(19) United States
(12) Patent Application Publication
(10) Pub. No.: US 2011/0317306 A1
(43) Pub. Date: Dec. 29, 2011

(54) MAGNETIC RECORDING APPARATUS, MAGNETIC RECORDING METHOD, AND MAGNETIC RECORDING MEDIUM

(75) Inventors: Akihiro Itakura, Akishima-shi (JP); Masatoshi Sakurai, Tokyo (JP); Kazuhito Shimomura, Fussa-shi (JP)

(73) Assignee: Kabushiki Kaisha Toshiba, Tokyo (JP)

(21) Appl. No.: 13/091,401

(22) Filed: Apr. 21, 2011

(30) Foreign Application Priority Data
Jun. 28, 2010 (JP) 2010-146756

(51) Int. Cl. G11B 5/02; G11B 5/706

(52) U.S. Cl. 360/55; 428/846; G9B/5.026

(57) ABSTRACT

According to one embodiment, there is provided a magnetic recording medium which includes a plurality of magnetic dot rows in which there is a phase shift between adjacent dot rows, and dots are arranged in a zigzag manner in a predetermined number of dot rows which are simultaneously read.

### CROSS-REFERENCE TO RELATED APPLICATIONS

This application is based upon and claims the benefit of priority from Japanese Patent Application No. 2010-146756, filed Jun. 28, 2010; the entire contents of which are incorporated herein by reference.

### FIELD

Embodiments described herein relate generally to a magnetic recording apparatus such as a hard disk apparatus, a magnetic recording method, and a magnetic recording medium.

### BACKGROUND

With improvement in function and increase in speed of information apparatuses such as personal computers and hard disk recorders, quantity of information which the users deal with has increased more and more in recent years. Therefore, it is eagerly desired to increase the recording density of recording media of information recording apparatuses. To increase the recording density, it is necessary to miniaturize the size of each recording cell or recording mark which is a recording writing unit in recording media. However, in conventional recording media, miniaturization of recording cells or recording marks is confronted with a large difficulty.

Current recording media of hard disk apparatuses have a structure in which a granular thin film which has a thickness of 10 nm or so is deposited on a disk substrate. When the size of grains of the granular thin film is reduced to increase the recording density, recording with small polycrystalline grains becomes unstable due to thermal fluctuation (the phenomenon that the ratio of the magnetic energy to the heat energy decreases when the volume of magnetic grains is reduced, and recording magnetization changes or disappears due to influence by temperature). Therefore, reduction in the size of recording cells causes unstableness of recording and increase in noise, which are not caused in recording media having recording cells of a large size. This is because the number of crystalline grains included in a recording cell is reduced, and interaction between recording cells relatively increases.

To avoid the above problem, bit patterned media (BPM) (which is also simply referred to as “patterned media”) have been proposed as next-generation magnetic recording media, which replaces thin-film recording media. Bit patterned media have a structure in which recording material is divided into parts in advance by non-recording material, and a single recording material grain is used as a single recording cell to perform recording and reproducing.

Bit patterned media are formed of a magnetic dot array which is formed by regularly arranging micro magnets (magnetic dots) with the scale of nanometer on a substrate, and in which a digital signal of “0” or “1” (1 dot corresponds to 1 bit) is recorded according to the direction of magnetization of each magnetic dot. In bit patterned media, bits are physically completely independent of each other, and thus there is no noise caused by magnetization transition, which serves as main factor that obstructs increase in recording density in a continuous film medium.

On the other hand, in current recording media of hard disk apparatuses, which are formed by depositing a granular thin film, when a recording head records data in a specific position of the recording media, a recording error hardly occurs since the surface of the media is uniform, even when the writing position is slightly shifted in a track direction due to shift of writing start timing.

However, in patterned media in which the recording material is divided into parts by non-recording material in the surface of the recording media, when the recording head records data in a specific position of the recording media, it is important to start recording by the recording head in exact timing, since it is necessary to write data in divided recording cells one by one. When recording is started untimely, the recording head performs writing in a non-recording material part or over adjacent recording cells, and thus writing errors increase.

The dot arrangement pattern of the bit patterned media includes a lattice (square) pattern and a staggered pattern. In a lattice pattern in which dots are arranged in rows and columns, a dot row is considered as one track of data, and strict conditions are required as conditions for the cross-track direction such as the head core width and tracking.

A staggered pattern is considered as measure for solving the problem. In a staggered pattern, in a number of dot rows which are arranged at certain dot pitch, the phase of a dot row of an odd number is shifted by 180° from the phase of a dot row of an even number. The head has a width by which the head can simultaneously access two dot rows. When data is recorded, the head writes the data in the order of the first dot of the first row, the first dot of the second row, the second dot of the first row . . . , while the head is moved along the dot rows. In the same manner, when data is reproduced, the data is read from the first dot of the first row, the first dot of the second row, the second dot of the first row . . . , while the head is moved along the dot rows. As described above, adjacent two dot rows are used as one data track. Thereby, the staggered pattern has track pitch twice as large as that of the lattice pattern, and bit pitch ½ as large as that of the lattice pattern. One of factors which determine the write phase margin that indicates an allowable error range relating to the positions of the head and the dot in writing is a space between dots (dot pitch). However, since the staggered pattern uses two dot rows as one data track and the dot pitch of the staggered pattern is halved, the write phase margin of the staggered pattern is smaller than that of the lattice pattern. Therefore, a high degree of accuracy is required for manufacturing the disk and the head in the case of using the staggered pattern.

As described above, magnetic recording apparatuses using conventional bit patterned media have a small write phase margin, and have a defect that write errors easily occur. To prevent the defect, there is a problem that strict processing accuracy is required in manufacturing.

The object of embodiments of the present invention is to provide dot arrangement which achieves easing of processing conditions and reduction in interference between tracks during multi-track reading, and thereby achieve increase in recording density.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram illustrating a configuration of a magnetic recording apparatus according to an embodiment of the present invention.

FIG. 2A is a diagram for explaining a method which is proposed to increase the write phase margin, and FIG. 2B is a diagram for explaining a method of reproducing data recorded by the method.

FIG. 3A is a diagram obtained by enlarging the dot arrangement of FIG. 2A, and FIG. 3B is a diagram illustrating a dot arrangement according to Embodiment 1 of the present invention.

FIG. 4A is a diagram illustrating another proposed dot arrangement, and FIG. 4B is a diagram illustrating a dot arrangement according to Embodiment 2 of the present invention.

FIG. 5A is a diagram illustrating another proposed dot arrangement, and FIG. 5B is a diagram illustrating a dot arrangement according to Embodiment 2 of the present invention.

FIG. 6A is a diagram illustrating another proposed dot arrangement, and FIG. 6B is a diagram illustrating a dot arrangement according to Embodiment 3 of the present invention.

FIG. 7A is a diagram for explaining adjacent dots which may interfere when the head has skew, and FIG. 7B is a dot arrangement according to Embodiment 3 of the present invention.

### DETAILED DESCRIPTION

Various embodiments will be described hereinafter with reference to the accompanying drawings.

In general, according to one embodiment, there is provided a magnetic recording medium which includes a plurality of magnetic dot rows in which there is a phase shift between adjacent dot rows, and dots are arranged in a zigzag manner in a predetermined number of dot rows which are simultaneously read.

Embodiments of the present invention will be explained hereinafter in detail with reference to drawings.

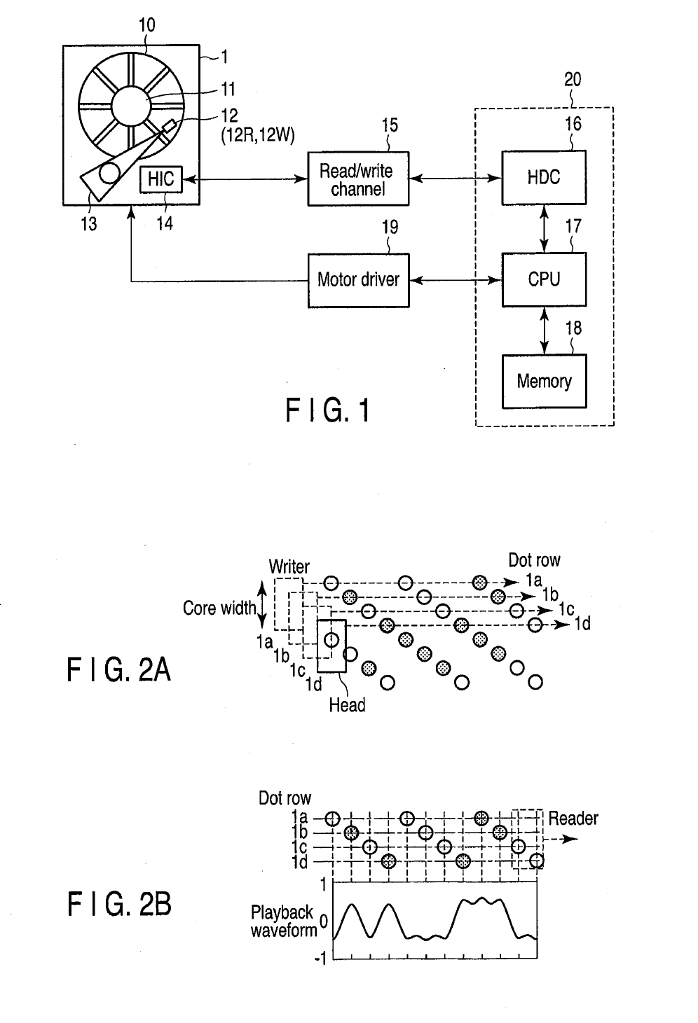

FIG. 1 is a block diagram illustrating a configuration of a magnetic recording apparatus according to embodiments of the present invention.

A disk drive 1 comprises a disk 10 which is a magnetic recording medium, a spindle motor (SPM) 11 which rotates the disk 10, a head 12, an actuator 13, and a head amplifier unit (head IC) 14. The disk 10 is formed of a bit patterned medium that is formed of a magnetic dot array which is formed by regularly arranging micro magnets (magnetic dots) with the scale of nanometer on a substrate, and in which a digital signal of “0” or “1” (one dot corresponds to one bit) is recorded according to the direction of magnetization of each magnetic dot.

The head 12 has a structure in which a read head element 12R and a write head element 12W are mounted on a slider separately from each other. The read head 12R reads out data recorded on the disk 10. The write head element 12W writes data on the disk 10. The actuator 13 includes a suspension, on which the head 12 is mounted, an arm, and a voice coil motor (VCM). The actuator 13 moves the head 12 in a radial direction (cross track direction) on the disk 10 for tracking control.

The head amplifier unit 14 includes a read amplifier, which amplifies a read signal that is read out by the read head element 12R of the head 12 and outputs the read signal to a read/write channel 15. In addition, the head amplifier unit 14 includes a write driver, which converts write data that is outputted from the read/write channel 15 into a write signal (write current), and supplies the write signal to the write head element 12W of the head 12.

The disk drive 1 includes the read/write channel 15, a hard disk controller (HDC) 16, a microprocessor (CPU) 17, a memory 18, and a motor driver 19, which are mounted on a printed circuit board. The HDC 16, the CPU 17, and the memory 18 are mounted on a one-chip integrated circuit 20.

The read/write channel 15 is a signal processing unit which processes read/write data signals. The HDC 16 forms an interface between the disk drive 1 and a host system (such as a personal computer and a digital apparatus) which is not shown, and controls data transmission and read/write operation. The CPU 17 is a main controller of the disk drive 1, and performs head positioning control (servo control) and sorting of read/write data. The memory 18 is, for example, a flash EEPROM.

The motor driver 19 includes an SPM driver which supplies a drive current to the SPM 11, and a VCM driver which supplies a drive current to the VCM of the actuator 13. The VCM driver supplies a drive current to the VCM of the actuator 13 in response to a head positioning control (servo control) signal of the CPU 17, and moves and controls the head 12 in the radial direction on the disk 10.

Next, a magnetic recording medium and a magnetic recording method according to embodiments of the present invention will be explained hereinafter.

Since recording bits of a patterned medium are arranged in advance on the disk, it is important to synchronize the generated write magnetic field with magnetic dots when data is written. A method which is proposed to enlarge the write phase margin is explained with reference to FIG. 2A. This example shows the case where the dot phase has four periods. First, data is recorded in a state where an edge part of the write head is located in a dot row 1a. In the recording, recording is performed with a write frequency which corresponds to the dot pitch. As a result, the write phase margin can be increased in comparison with prior art. Next, data is recorded in a dot row 1b. The write phase in the recording is made agree with the dot phase. In addition, when recording is performed with a write head core width larger than the dot row, recording is performed simultaneously for a plurality of dot rows (dot rows 1b, 1c and 1d in FIG. 2A). In such a case, however, the edge part of the write head is used, and the dot rows are overwritten in order when recording is performed for the next dot row, and thus no problem occurs. The same control is performed while the head is shifted from one dot row to the next dot row, as if tiles were arranged, and recording is performed for the dot row 1c and the dot row 1d (hereinafter referred to as “shingled-write recording”). A method of reproducing data recorded as described above will now be explained with reference to FIG. 2B. When the data is reproduced, tracking is performed such that the center of the read head is located in the center of the dot rows 1a to 1d, that is, the center of the dot rows 1b and 1c, and the dot rows 1a to 1d are simultaneously reproduced. In the reproduced waveform, peak points do not overlap as in prior art, and can be detected by a conventional signal processing method, since the phases of dots of the dot rows which are simultaneously reproduced are shifted from one another.

For the above proposed technique, embodiments of the present invention provides dot arrangement which is aimed at further easing of processing conditions and reduction in interference between tracks during multi-track reading, and thereby achieves further increase in recording density.

### Embodiment 1

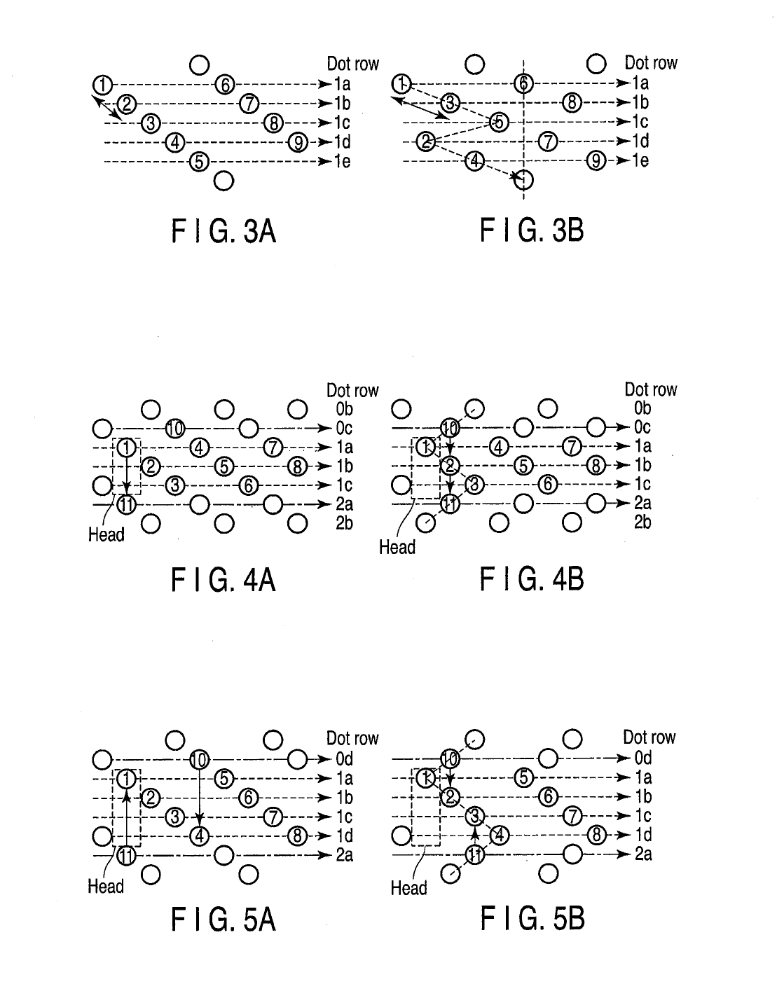

FIG. 3A is a diagram obtained by enlarging the dot arrangement of FIG. 2A.

With respect to dots of dot numbers 1, 2, 3, . . . (hereinafter referred to as dots 1, 2, and 3, . . . ), processing conditions, that is, necessary processing and positioning accuracy depend on the shortest distance between dots (distance between dots 1 and 2, distance between dots 2 and 3, . . . ). In Embodiment 1, the dot arrangement of FIG. 3A is changed to arrangement illustrated in FIG. 3B. Specifically, arrangement of dot rows 1a, 1b, 1c, 1d, and 1e of FIG. 3A is changed to arrangement in the order of dot rows 1a, 1c, 1e, 1b, and 1d, and thereby dots are arranged in a zigzag manner. Specifically, in the present embodiment, dots are arranged in a zigzag manner in a predetermined number of dot rows (five dot rows in Embodiment 1) which are simultaneously read. Thereby, the shortest distance between dots (distance between dots 1 and 3, distance between dots 3 and 5) is increased, and processing conditions can be eased for that.

The arrangement of the dot rows (bit data) are changed by the controller when the data is written, such that data can be read in the order of user data (in the order of dot numbers) during multi-track reading. As illustrated in FIG. 3B, since shingled-write recording is performed in the order of dot rows 1a, 1c, 1e . . . , the controller performs data conversion of converting user data in the order of dot 1, 6 . . . , dots 3, 8 . . . , dots 2, 7 . . . in recording. When the data is read, since the dot rows 1a to 1d are simultaneously reproduced, dot numbers of the dots which are read are arranged in the order of 1, 2, 3, 4, 5, 6, 7, 8, 9 . . . which is the same as the user data.

As described above, according to Embodiment 1, the required processing accuracy of dots can be eased, and it is possible to achieve recording with higher density than prior art.

### Embodiment 2

FIG. 4A illustrates another proposed dot arrangement, and the problem of the arrangement is explained first.

This example shows a dot arrangement based on the assumption that three dot rows (1a, 1b, and 1c) are simultaneously read out. During multi-track reading, the core width of the read head is a width which covers a plurality of tracks (a range enclosed by a rectangular dotted line). However, the sensitivity distribution in the cross track direction (radial direction) of the head is not uniform, but the sensitivity is the maximum in the center and gradually decreases toward the edge. Therefore, when a plurality of tracks are read, there is a tendency that tracks located at the edge part of the head have a smaller amplitude than that of tracks in the center part. Specifically, in FIG. 4A, the amplitude of dot 2 is large, and dots 1 and 3 have a small amplitude. Inter-track interference from adjacent tracks will be considered hereinafter. Dots 10 and 11 are adjacent to the head, dots 10 and 3 are simultaneously read, and dots 11 and 1 are simultaneously read. Therefore, dots 3 and 1 which have a small signal amplitude are relatively more easily influenced by inter-track interference than dot 2 is.

FIG. 4B illustrates an embodiment of the present invention, which reduces inter-track interference of FIG. 4A. The embodiment is characterized in that dots are arranged in a zigzag manner, not simply shifting arrangement of dots between tracks in a straight line manner. Specifically, in Embodiment 2, dots are arranged in a zigzag manner, and dots of a predetermined number of dot rows (three rows in the present embodiment) which are simultaneously read are arranged in a straight line manner.

In this state, when dots 1, 2 and 3 are reproduced, inter-track interference is caused by influence from dots 10 and 11. The influence from dots 10 and 11 is large when dot 2 is reproduced. However, since dot 2 is positioned in the center of the head, and dot 2 has a large signal amplitude. Therefore, it is possible to relatively reduce influence of inter-track interference from adjacent tracks.

The problem of the case where four dot rows (1a, 1b, 1c, and 1d) are simultaneously reproduced will be explained hereinafter, with reference to FIG. 5A which illustrates a dot arrangement similar to that of FIG. 4A. Also during the multi-track reading, the core width of the read head is a width which covers a plurality of tracks (a range enclosed by a rectangular dotted line), and the sensitivity in the cross track direction of the head is maximum in the center of the head and gradually decreases toward the edge. Therefore, dots 2 and 3 have a large amplitude, and dots 1 and 4 have a small amplitude. Dots 11 and 10 of adjacent tracks are read simultaneously with dots 1 and 4, respectively, and thus inter-track interference relatively increases. Specifically, dot 11 interferes when dot 1 is read, and dot 10 interferes when dot 4 is read.

FIG. 5B illustrates an embodiment of the present invention, which reduces inter-track interference of FIG. 5A. In the same manner as the case of reading three dot rows, dots are arranged in a zigzag manner, and dots of a predetermined number of dot rows (four rows in the present embodiment) which are simultaneously read are arranged in a straight line manner. When dots 1, 2, 3 and 4 are reproduced, read timings of dots 2 and 3 agree with read timings of dots 10 and 11 of adjacent tracks. The dots 2 and 3 are located in the center of the head, and thus have a large signal amplitude. Therefore, it is possible to relatively reduce influence by inter-track influence from adjacent tracks.

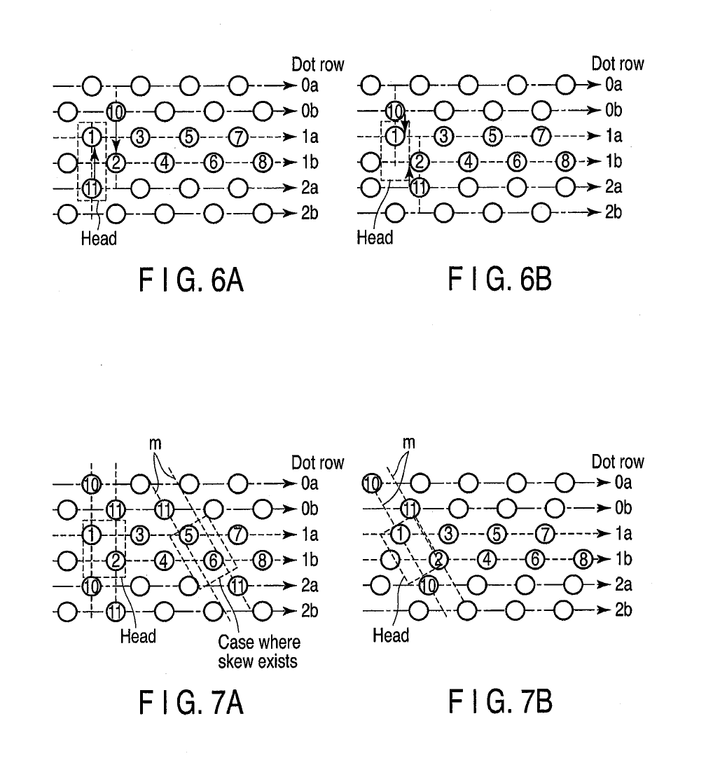

FIG. 6A illustrates a dot arrangement in which two dot rows (1a, 1b) can be simultaneously reproduced. When two dot rows are simultaneously reproduced, the head is positioned in the center of the dot rows, and thus dots 1 and 2 have the same amplitude. However, suppose that track offset occurs in the above case. In FIG. 6A, when the read head is offset toward the dot row 2a, the amplitude of dot 1 decreases due to sensitivity distribution of the head. Simultaneously, inter-track interference from the adjacent dot 11 increases. Conversely, when the head is offset toward the dot row 0b, the amplitude of dot 2 decreases, and interference from the adjacent dot 10 increases. As described above, the signal quality deteriorates due to track offset.

FIG. 6B illustrates an embodiment of the present invention, which solves the above problem. The dot arrangement is characterized in that phases of dot positions of two dot rows which are simultaneously read are shifted from each other by 180°, and the phase of dot arrangement is shifted by 180° for every two dot rows. Specifically, dot row 0b including dot 10 and the adjacent dot row 0a have been shifted toward the left in FIG. 6B, and dot row 2a including dot 11 and the adjacent dot row 2b have been shifted toward the right in FIG. 6B.

When track offset toward the dot row 2a occurs, the amplitude of dot 1 decreases as described above. In the present embodiment, however, interference from the adjacent dot 10 simultaneously decreases. Conversely, when the head is offset toward the dot row 0b, the amplitude of dot 2 decreases, and interference from the adjacent dot 11 also decreases. As described above, signal deterioration due to track offset can be suppressed. The present embodiment has the similar effect also for the cases of FIG. 4B and FIG. 5B where three or four dot rows are simultaneously read.

As described above, according to Embodiment 2, it is possible to reduce inter-track interference caused by multi-track reading, and achieve increase in recording density in comparison with prior art.

### Embodiment 3

FIG. 7A illustrates a dot arrangement in which two dot rows (1a, 1b) can be simultaneously read, like FIG. 6A. Another problem in the dot arrangement will be explained hereinafter. In ordinary hard disks, the skew angle of the head changes according to the radial position of the head. Examples of the positions of the head are illustrated with dot 1 (2) and dot 5 (6) in FIG. 7A. The head is easily influenced by an adjacent dot located in the core width direction (direction of dotted line m in FIG. 7A), and such a dot is referred to as adjacent dot. In dot 1 without skew, the adjacent dot is dot 10 located in the vertical direction (the adjacent dot of dot 2 is dot 11). On the other hand, the adjacent dot of dot 5 with skew is dot 11. As a result, interference from dot 11 increases, and signal deterioration is caused. As illustrated in FIG. 7B, in the present embodiment, dots are arranged such that the phase of the adjacent dot row is shifted (dot 10 for dot 1, dot 11 for dot 2) in the same direction as the skew of the head, in accordance with the skew angle which changes according to the radial position. This arrangement keeps a sufficient distance between adjacent dots, and influence by interference can be eliminated.

As described above, according to Embodiment 3, it is possible to reduce interference between dots due to skew, and achieve increase in recording density in comparison with prior art.

The above explanation is embodiments of the present invention, and does not limit the apparatus or method of the present invention, but various modifications can be easily performed. For example, various inventions can be formed by proper combinations of constituent elements disclosed in the above embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording medium comprising a plurality of magnetic dot rows in which there is a phase shift between adjacent dot rows,
wherein dots of a predetermined number of dot rows which are simultaneously read are arranged in a zigzag manner.

2. A magnetic recording medium comprising a plurality of magnetic dot rows in which there is a phase shift between adjacent dot rows,
wherein dots are arranged in a zigzag manner, and dots of a predetermined number of dot rows which are simultaneously read are arranged in a straight line manner.

3. A magnetic recording medium comprising a plurality of magnetic dot rows in which there is a phase shift between adjacent dot rows,
wherein dots are arranged in units of two dot rows for simultaneously reading two dot rows, and a phase of dots of one unit including adjacent two dot rows is shifted from a phase of dots of an adjacent unit by 180°.

4. A magnetic recording medium comprising a plurality of magnetic dot rows in which there is a phase shift between adjacent dot rows,
wherein a phase of an adjacent dot row is set to agree with a head skew angle which changes according to a radial position of the head.

5. A magnetic recording apparatus which records data on the magnetic recording medium of claim 1 by a shingled-write recording method, comprising:
a recording head which covers a plurality of dot rows, and has an edge part that is positioned on one dot row in which data is to be recorded;
an actuator which moves the recording head by one dot row after data is recorded in the one dot row by the recording head; and
a controller which converts a recording order of input user data when the input user data is recorded as a plurality of magnetic dots, such that the user data can be read in order of the input user data during multi-track reading.

6. A magnetic recording method which records data on the magnetic recording medium of claim 1, comprising:
converting a recording order of input user data when the input user data is recorded as a plurality of magnetic dots, such that the user data can be read in order of the input user data during multi-track reading;
positioning an edge part of a recording head, which covers a plurality of dot rows, on one dot row in which data is to be recorded, and recording the user data with the converted order in the one dot row; and
moving the recording head by one dot row, and successively recording the user data with the converted order in each dot row by a shingled-write recording method.
